(19) United States
(12) Patent Application Publication
(10) Pub. No.: US 2010/0307539 A1
(43) Pub. Date: Dec. 9, 2010

(54) SUBSTRATE LIQUID PROCESSING APPARATUS, SUBSTRATE LIQUID PROCESSING METHOD, AND STORAGE MEDIUM HAVING SUBSTRATE LIQUID PROCESSING PROGRAM STORED THEREIN

(75) Inventors: Nobuhiko MOURI, Koshi-City (JP); Shoichiro HIDAKA, KOshi-City (JP)

Correspondence Address: CANTOR COLBURN LLP, 20 Church Street, 22nd Floor, Hartford, CT, 06103, US

(73) Assignee: TOKYO ELECTRON LIMITED, Tokyo (JP)

(21) Appl. No.: 12/794,074

(22) Filed: Jun. 4, 2010

(30) Foreign Application Priority Data
Jun. 4, 2009 (JP) 2009-135261

(51) Int. Cl. B08B 3/00

(52) U.S. Cl. 134/33; 134/157

(57) ABSTRACT

A substrate liquid cleaning process is disclosed by utilizing a substrate liquid processing apparatus having, inter alia, a rotating mechanism that rotates a substrate to be cleaned, a peripheral edge cleaning mechanism that cleans the peripheral edge of the substrate by a rotating cleaning body, and a cleaning solution supply mechanism that supplies the cleaning solution to the substrate. The substrate liquid cleaning process is performed by contacting the rotating cleaning body to a peripheral edge of a rotating substrate while supplying a cleaning solution. The rotational direction of the substrate and the cleaning body is set to be an opposite direction so that the proceeding direction of the substrate and the cleaning body becomes the same at a contacting portion where the substrate and the cleaning body are contacted. A rotational speed ratio of the substrate and the cleaning body is set to be about 1:1˜3.5:1.

This application is based on and claims priority from Japanese Patent Application No. 2009-135261, filed on Jun. 4, 2009, with the Japanese Patent Office, the disclosure of which is incorporated herein in its entirety by reference.

### TECHNICAL FIELD

The present disclosure relates to a substrate liquid processing apparatus, substrate liquid processing method, and storage medium that stores a program for the substrate liquid processing method.

### BACKGROUND

Cleaning processes for semiconductor substrates have been known in semiconductor device fabrication processes. The surface of substrates are cleaned in substrate cleaning processes because contaminated surfaces with contaminants such as particles will affect patterning processes, for example, by an exposure, because various important structures such as circuit patterns are formed on the surface of a semiconductor substrate. Moreover, if a peripheral edge of a substrate is contaminated, contaminants may be spread into other substrates when the contaminated substrate is transferred or processed. Also, when the contaminated substrate is processed by an immersion process or liquid immersion lithography, contaminants may be floating around in the immersion solution and re-attached to the surface of a substrate to be processed. Accordingly, the peripheral edge of the substrate needs to be cleaned in the substrate cleaning process.

A substrate liquid processing apparatus used to clean the peripheral edge of a substrate includes a rotating mechanism that rotates the substrate while maintaining the substrate in a horizontal direction, a peripheral edge cleaning mechanism that cleans the peripheral edge of the substrate by contacting a cleaning body that is rotating to the peripheral edge of the substrate, and a cleaning solution supply mechanism that supplies a cleaning solution to the center of the substrate. The cleaning solution is then delivered to the peripheral edge of the substrate by a centrifugal force of the rotating substrate. See, for example, Japanese Patent Laid-Open No. 2006-278592.

### SUMMARY

A substrate liquid processing apparatus comprises a rotating mechanism that rotates a substrate, a cleaning mechanism that cleans a peripheral edge of the substrate with a cleaning body configured to be rotated, a supply mechanism that supplies a cleaning solution to the substrate. In particular, the substrate liquid processing apparatus is configured in such a way that a rotational direction of the substrate by the rotating mechanism is set to be an opposite direction to a rotational direction of the cleaning body by the cleaning mechanism. As a result, a proceeding direction of the substrate and the cleaning body is the same at a contact portion where the substrate and the cleaning body are contacted. The substrate liquid processing apparatus is further configured that a ratio of a rotational velocity of the substrate rotated by the rotating mechanism to a rotational velocity of the cleaning body rotated by the cleaning mechanism ranges from about 1:1 to about 3.5:1.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of a substrate liquid processing apparatus according to the present disclosure.

FIG. 2 is a plan view of a substrate cleaning unit.

FIG. 3 is a side view of the substrate cleaning unit.

FIG. 4(a) is an explanatory view illustrating the operation of the substrate and a cleaning body during a cleaning process, and FIG. 4(b) is an exploded view of a portion of FIG. 4(a).

FIG. 5 is a graph showing a relationship between a rotational speed of the cleaning body versus a cleaning efficiency when a rotational speed of the substrate is maintained at a constant speed.

FIG. 6 is a graph showing a relationship between a rotational speed of the substrate versus a cleaning efficiency when a rotational speed of the cleaning body is maintained at a constant speed.

FIG. 7 is a graph showing a relationship between the ratio of the rotational speed of the substrate to the rotational speed of the cleaning body versus a cleaning efficiency.

FIG. 8(a) is a plan view of the cleaning body, and FIG. 8(b) is a cross-sectional side view of the cleaning body.

FIG. 9(a) is a plan view of another cleaning body, and FIG. 9(b) is a cross sectional side view of another cleaning body.

FIG. 10(a) is a plan view of yet another cleaning body, and FIG. 10(b) is a cross sectional side view of yet another cleaning body.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

In the substrate liquid processing apparatus of the present disclosure, the peripheral edge of a substrate is cleaned with a cleaning solution by rotating the substrate and a cleaning body of the substrate liquid processing apparatus together so that a cleaning efficiency which is a removing rate of contaminants at the peripheral edge of the substrate varies depending on a rotational speed of the substrate and the cleaning body. The present disclosure provides a substrate liquid processing apparatus and method thereof suitable for cleaning the peripheral edge of the substrate with the cleaning solution by contacting the substrate and the cleaning body of the substrate liquid processing apparatus rotating together.

According to an embodiment of the present disclosure, a substrate liquid processing apparatus comprises a rotating mechanism that rotates a substrate, a cleaning mechanism that cleans a peripheral edge of the substrate with a cleaning body configured to be rotated, a supply mechanism that supplies a cleaning solution to the substrate. In particular, the substrate liquid processing apparatus is configured in such a way that a rotational direction of the substrate rotated by the rotating mechanism is set to be an opposite direction to a rotational direction of the cleaning body rotated by the cleaning mechanism so that a proceeding direction of the substrate and the cleaning body is the same at a contact portion where the substrate and the cleaning body are contacted. The substrate liquid processing apparatus is further configured that a ratio of a rotational speed of the substrate to a rotational speed of the cleaning body may be set to range from about 1:1 to about 3.5:1.

In the substrate processing apparatus, the ratio of the rotational speed of the substrate to the rotational speed of the cleaning body may range from about 1.5:1 to about 3:1. In particular, the ratio of the rotational speed of the substrate to the rotational velocity of the cleaning body may be about 2:1. Moreover, the cleaning body is built with different kinds of cleaning members each formed on one of areas where the cleaning body is divided by half along a circumferential direction. In particular, the cleaning body may be built with a brush-shape cleaning member and a sponge-shape cleaning member each formed on one of respective areas where the cleaning body is divided by half along the circumferential direction.

According to another embodiment of the present disclosure, a substrate liquid processing method comprises rotating a substrate by a rotating mechanism, cleaning a peripheral edge of the substrate by a cleaning body of a cleaning mechanism, where the cleaning body may be configured to be rotated by the cleaning mechanism, and supplying a cleaning solution to the substrate by a supply mechanism. Specifically, the substrate liquid processing method may further include a first setting step where a rotational direction of the substrate is set to be an opposite direction to a rotational direction of the cleaning body so that a proceeding direction of the substrate and the cleaning body may be the same at a contact portion where the substrate and the cleaning body are contacted. The substrate liquid processing method may further include a second setting step where a ratio of a rotational speed of the substrate to a rotational speed of the cleaning body may be set to range from about 1:1 to about 3.5:1.

In the substrate processing method, the ratio of the rotational speed of the substrate to the rotational speed of the cleaning body at the second setting step may be set to range from about 1.5:1 to about 3:1. In particular, the ratio of the rotational speed of the substrate to the rotational speed of the cleaning body may be set to be about 2:1. Moreover, the cleaning body is built with different kinds of cleaning members each formed on one f areas where the cleaning body is divided by half along a circumferential direction. Furthermore, the cleaning body includes a brush-shape cleaning member and a sponge-shape cleaning member each formed on one of areas where the cleaning body is divided by half along the circumferential direction.

According to yet another embodiment of the present disclosure, a computer-readable medium storing a program that, when executed, causes a computer to perform a substrate liquid processing method comprises rotating a substrate by a rotating mechanism, cleaning a peripheral edge of the substrate by a cleaning body of a cleaning mechanism, where the cleaning body may be configured to rotate by the cleaning mechanism, supplying a cleaning solution to the substrate by a supply mechanism, a first setting of setting a rotational direction of the substrate rotated by the rotating mechanism to be an opposite direction to a rotational direction of the cleaning body rotated by the cleaning mechanism so that a proceeding direction of the substrate may be the same as a proceeding direction of the cleaning body at a contact portion where the substrate and the cleaning body are contacted, and a second setting step of setting a ratio of a rotational speed of the substrate rotated by the rotating mechanism to the rotational speed of the cleaning body rotated by the cleaning mechanism to range from about 1:1 to about 3.5:1.

Additionally, in the substrate liquid processing method stored in the computer-readable medium, the ratio of the rotational speed of the substrate to the rotational speed of the cleaning body at the second setting step may be set to range from about 1.5:1 to about 3:1. Furthermore, the ratio of the rotational speed of the substrate to the rotational speed of the cleaning body at the second setting step may be set to be about 2:1.

According to the present disclosure, the rotational direction of the substrate and the rotational direction of the cleaning body are set to be an opposite direction so that the proceeding direction of the substrate and the cleaning body is the same at a contact portion where the substrate and the cleaning body are contacted. Moreover, the ratio of the rotational speed of the substrate to the rotational speed of the cleaning body is set to be about 1:1˜3.5:1. As a result, the cleaning efficiency of the substrate (a removing rate of contaminants) may be improved.

A description regarding the specifics of the substrate liquid processing apparatus of the present disclosure will be followed by referring to the figures.

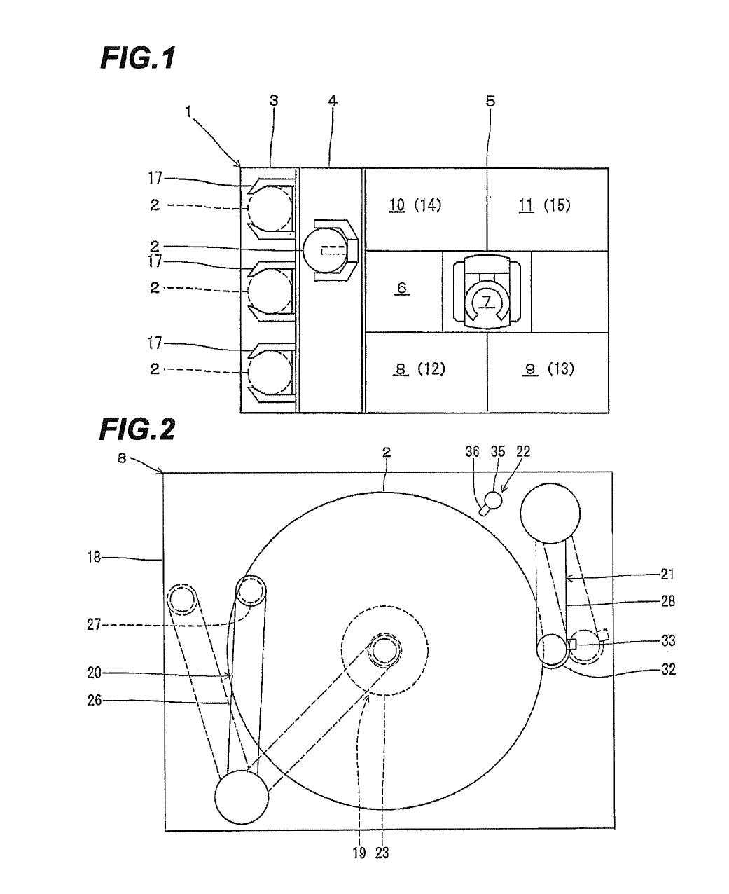

As illustrated in FIG. 1, substrate liquid processing apparatus 1 includes a load/unload unit 3 formed at the front area of the substrate liquid processing apparatus. Load/unload unit 3 is configured to load/unload semiconductor wafers (“substrate 2” hereinafter), a transfer unit 4 formed at the rear area of load/unload unit 3 configured to transfer substrate 2, and liquid processing unit 5 formed at the rear area of transfer unit 4 configured to conduct various processes such as cleaning or drying out processes for substrate 2.

In liquid processing unit 5, a delivery unit 6 is formed at the rear area of transfer unit 4 configured to deliver substrate 2 to the rear area of transfer unit 4, and a transfer unit 7 is formed at the rear area of delivery unit 6 configured to transfer substrate 2 within liquid processing unit 5. Also, a total of eight cleaning units 8, 9, 10, 11, 12, 13, 14, 15 are installed on both sides of transfer unit 7 configured to clean substrate 2. Namely, two cleaning units are installed side by side on each of the top, bottom, right and left side of transfer unit 7.

In substrate liquid processing apparatus 1, a plurality of substrates 2 housed in carrier 17 placed in load/unload unit 3 are transferred to delivery unit 6 one by one by transfer unit 4, and further transferred, by transfer unit 7, to one of cleaning units 8, 9, 10, 11, 12, 13, 14, 15 where the plurality of substrates 2 are cleaned. Substrates 2 are then transferred back to delivery unit 6 by transfer unit 7, and further returned to carrier 17 of load/unload unit 3 by transfer unit 4.

Next, a description regarding the specific structure of cleaning units 8, 9, 10, 11, 12, 13, 14, 15 of substrate liquid processing apparatus will be followed. While the following description is directed to cleaning unit 8 placed at the top-front portion, other cleaning units 9, 10, 11, 12, 13, 14, 15 may have substantially similar structures to cleaning unit 8.

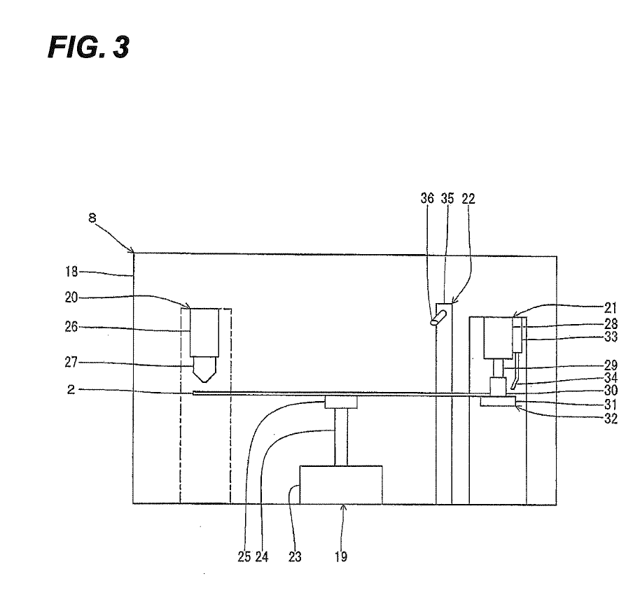

Referring to FIGS. 2 and 3, cleaning unit 8 includes a rotating mechanism 19 that rotates substrate 2 inside a chamber 18. Cleaning unit 8 further includes a surface cleaning mechanism 20 that cleans the surface (an upper surface) of substrate 2, a peripheral edge cleaning mechanism 21 that cleans the peripheral edge of substrate 2, and a cleaning solution supply mechanism 22 that supplies a cleaning solution to substrate 2.

The following describes specific structures of each of rotating mechanism 19, surface cleaning mechanism 20, peripheral edge cleaning mechanism 21, and cleaning solution supply mechanism 22 that forms cleaning unit 8.

Rotating mechanism 19 includes a driving motor 23 attached on the center of the bottom portion of chamber 18, and a holding member 25 that absorbs and holds substrate 2 on an upper portion of a rotating shaft 24 of driving motor 23. Rotating mechanism 19 rotates substrate 2, transferred to holding member 25 by transfer unit 7, at a predetermined speed while maintaining substrate 2 on a horizontal direction on holding member 25. Surface cleaning mechanism 20 is formed by attaching a moving mechanism 26 to chamber 18, and by attaching a cleaning nozzle 27 to the front-end portion of moving mechanism 26.

Using moving mechanism 26, surface cleaning mechanism 20 is configured to move a cleaning nozzle 27 horizontally between the upper-center portion of substrate 2 and the outside portion of a peripheral edge of substrate 2. Accordingly, cleaning nozzle 27 can be retreated to the outside portion of the peripheral edge of substrate 2 while substrate 2 is being transferred. Furthermore, cleaning nozzle 27 can move horizontally from the upper-center portion to the peripheral edge portion of substrate 2 during a cleaning process of an entire surface of substrate 2, and the surface of substrate 2 is cleaned by spraying droplets of a chemical solution toward the upper surface of substrate 2.

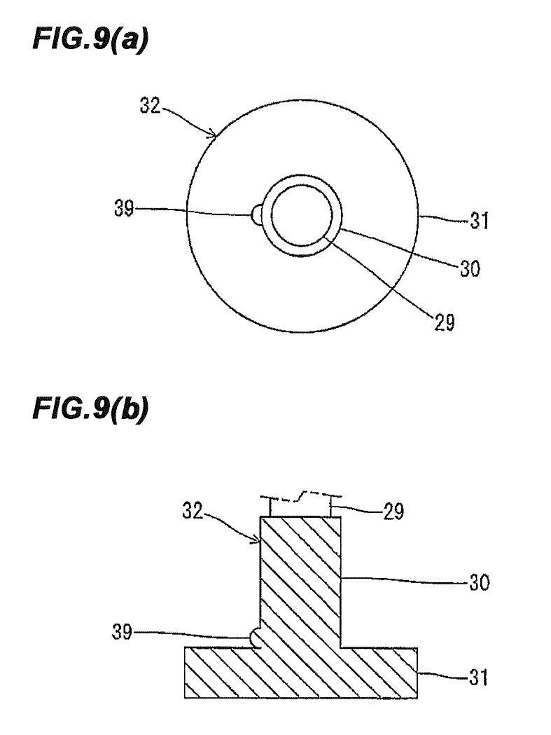

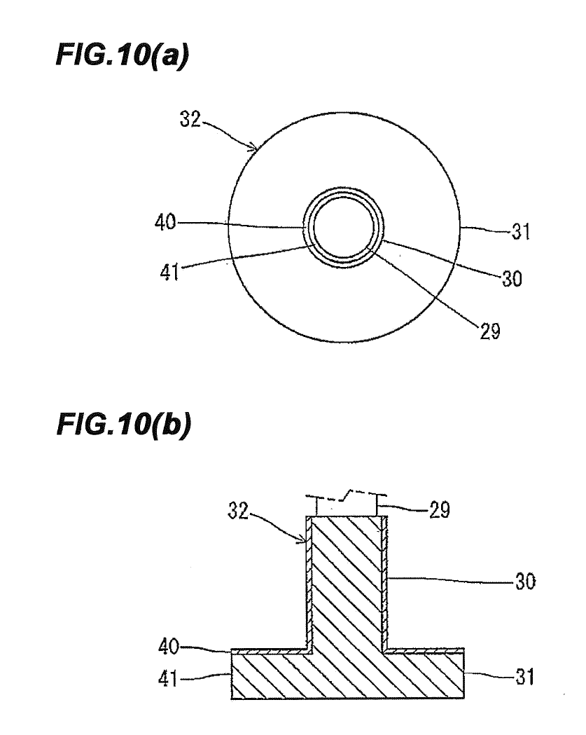

Peripheral edge cleaning mechanism 21 includes a moving mechanism 28 attached to chamber 18, and a rotating shaft 29 attached to a front-end of moving mechanism 28 where the front-end of rotating shaft 29 is directed to the lower side. Peripheral edge cleaning mechanism 21 further includes a cleaning body 32 having a T-shape cross section and formed on the front-end of rotating shaft 29 with a smaller diameter sponge 30 and a larger diameter sponge 31. Although, a sponge-shape cleaning member has been used for cleaning body 32 in this embodiment, cleaning body 32 may simply be configured to clean substrate 2 while cleaning body 32 is contacted with substrate 32, and a brush-shape cleaning member may also be used for cleaning body 32. As illustrated in FIG. 9, a small bump 39 may be formed at a contact portion where cleaning body 32 and substrate 2 are contacted. Bump 39 may be monitored for the abrasion to determine whether cleaning body 32 needs to be replaced, based on the appearance of bump 39. Also, as illustrated in FIG. 10, cleaning body 32 may also be formed with an outer sponge 40 and inner sponge 41 each having different colors so that a determination regarding replacement of the sponges can be made based on the appearance of the sponges

In peripheral edge cleaning mechanism 21, a supporting member 33 is attached to moving mechanism 28, and a nozzle 32 is attached to the lower portion of supporting member 33 directing toward cleaning body 32. Cleaning body 32 is configured to be moved horizontally between the peripheral edge of substrate 2 and outside portion of substrate 2 so that cleaning body 32 may be retreated to the outside portion of substrate 2 while substrate 2 is being transferred, and moved to the peripheral edge of substrate 2 while substrate 2 is being cleaned. Cleaning body 32 is configured in such a way that sponge 30 having a smaller diameter presses the edge of substrate 2 and the upper portion of sponge 31 having a larger diameter presses a lower periphery portion of substrate 2. Substrate 2 is then cleaned by rotating cleaning body 32 along shaft 29 thereby rubbing the periphery of substrate 2 with sponges 30, 31. At this time, peripheral edge cleaning mechanism 21 provides deionized water to cleaning body 32 via nozzle 34, and cleaning body 32 may then be swelled by the deionized water so that contaminants 32 such as particles may be removed from cleaning body 32.

In cleaning solution supply mechanism 22, a supporting member 35 is attached to chamber 18, a supply nozzle 36 is attached to an upper portion of supporting member 35 with an inclination so that supply nozzle 36 is directed toward the rotating center of substrate 2. Supply nozzle 36 discharges cleaning solution (deionized water in this embodiment) toward the rotating center of the surface of substrate 2 in an amount that can form a liquid layer on the surface of substrate 2 while rotating mechanism 19 rotates substrate 2. As a result, a liquid layer is formed on the surface of substrate 2 by the centrifugal force of the rotating substrate 2, and the cleaning solution is interposed in between the peripheral surface of the rotating substrate 2 and cleaning body 32 rotated by peripheral edge cleaning mechanism 21. In particular, the liquid layer formed on the surface of substrate 2 by the centrifugal force prevents the cleaning solution including particles from being re-attached to substrate 2.

In cleaning unit 8 constituted as described above, substrate 2 may be cleaned according to a method as described hereinafter, for example, by appropriately controlling rotating mechanism 19, surface cleaning mechanism 20, peripheral edge cleaning mechanism 21, and cleaning solution supply mechanism 22 along with a substrate liquid processing program stored at a controller (not shown).

Initially, transfer unit 7 transfers substrate 2 to holding unit 25 of cleaning unit 8 and rotating mechanism 19 rotates substrate 2 with a predetermined direction and speed while maintaining substrate 2 in a horizontal direction on holding unit 25. Cleaning solution supply mechanism 22 provides a predetermined amount of cleaning solution to the surface center of substrate 2 to form a liquid layer on the rotating substrate 2, and moving mechanism 28 moves cleaning body 32 toward substrate 2 while rotating cleaning body 32 with a predetermined direction and speed so that cleaning body 32 of peripheral edge cleaning mechanism 21 that contacts the peripheral edge of substrate 2 cleans the peripheral edge of substrate 2.

Subsequently, surface cleaning mechanism 20 and peripheral edge cleaning mechanism 21 are retreated to the outside portion of the peripheral edge of substrate 2, and cleaning solution supply mechanism 22 supplies the cleaning solution to substrate 2 thereby rinsing substrate 2.

Next, cleaning solution supply mechanism 22 supplies a predetermined amount of cleaning solution to the surface center of substrate 2 to form a liquid layer, moving mechanism 26 moves nozzle 27 from the upper center portion to the upper periphery portion of substrate 2 so that surface cleaning mechanism 20 cleans the surface of substrate 2 where circuit patterns are formed.

Following the processes described above, cleaning solution supply mechanism 22 stops supplying the cleaning solution, and rotating mechanism 19 rotates substrate 2 with a higher speed than in the cleaning process so that the cleaning solution is released from substrate 2 by the centrifugal force of the rotating substrate 2 thereby drying out substrate 2.

As described above, cleaning unit 8 of substrate liquid processing apparatus 1 cleans the peripheral edge of substrate 2 by rotating/contacting substrate 2 together with cleaning body 32. When substrate 2 and cleaning body 32 are rotated together for a cleaning process, the rotational direction of substrate 2 may be set either to be the same or opposite as compared to the rotational direction of cleaning body 32. However, when the rotational direction of substrate 2 is set to be the same as the rotational direction of cleaning body 32 so that the proceeding direction of substrate 2 is opposite to the proceeding direction of cleaning body 32 at a contact portion where the cleaning process is performed, cleaning efficiency tends to be decreased because cleaning body 32 may be elevated and slipped aside from substrate 2 due to the impact of the cleaning solution interposed between substrate 2 and cleaning body 32.

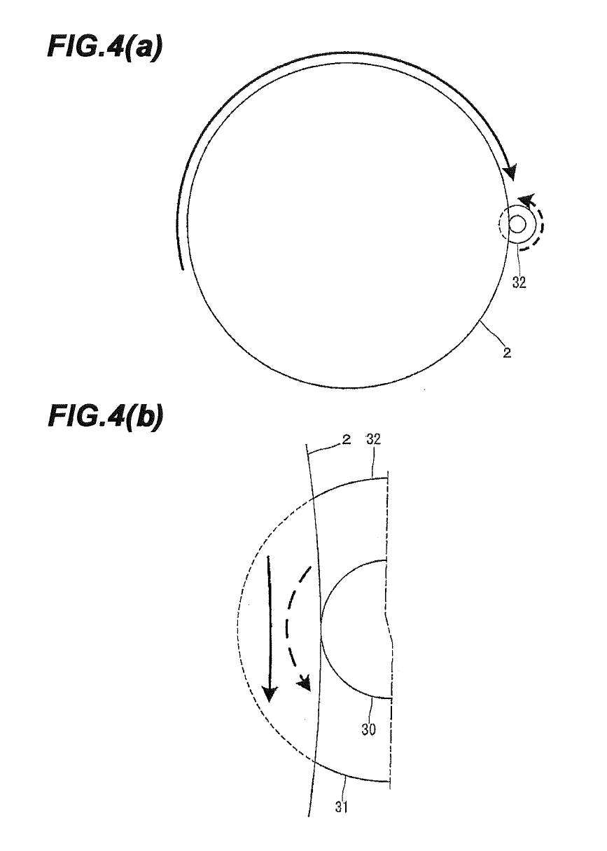

As illustrated in FIG. 4, substrate 2 has been rotated with a clockwise direction (a right turn) by rotating mechanism 19, and cleaning body 32 has been rotated with a counter-clockwise direction (a left turn) so that the rotational direction of substrate 2 is opposite to the rotational direction of cleaning body 32. As a result, the proceeding direction of substrate 2 and cleaning body 32 is the same at a contact portion where the cleaning process is performed. With these set up, an investigation has been made regarding the relationship between the rotational speed of substrate 2 or cleaning body 32 versus the cleaning efficiency.

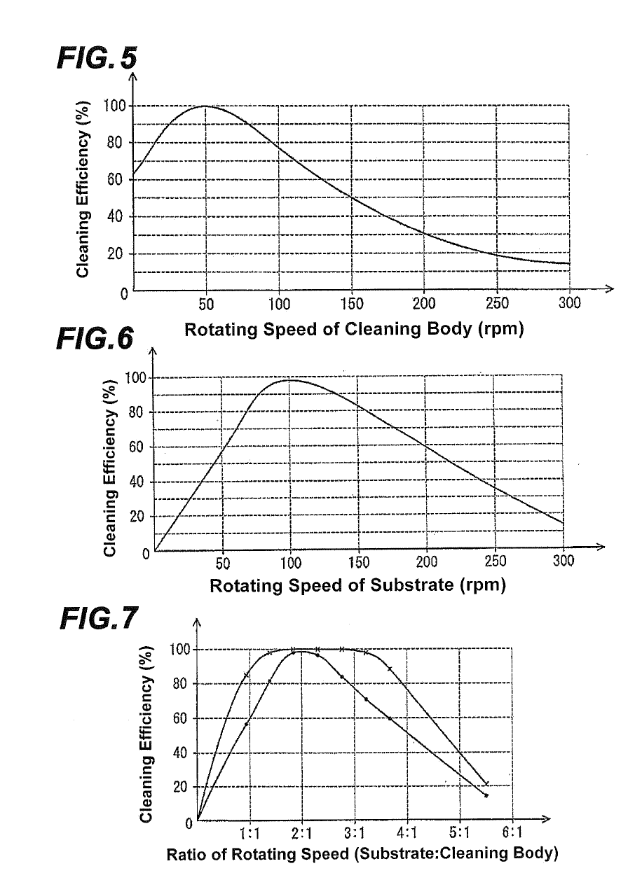

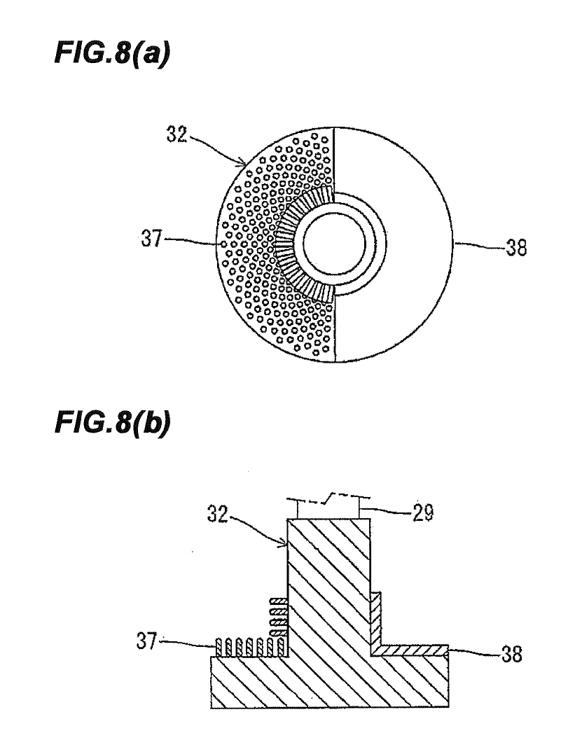

Referring to FIG. 5 where the rotating speed of cleaning body 32 is increased while the rotating speed of substrate 2 is fixed at 100 rpm, it has been found that the cleaning efficiency is increased as the rotating speed of cleaning body 32 is increased. It has been also found that the cleaning efficiency reaches its peak when the rotating speed of cleaning body 32 reaches at 50 rpm, and the cleaning efficiency is decreased gradually as the rotating speed of cleaning body 32 is further increased. The cleaning efficiency appears to be decreased when the rotating speed of cleaning body 32 is lower than 50 rpm because the number of contacts between substrate 2 and cleaning body 32 is small. In the mean time, when the rotation speed of cleaning body 32 is higher than 50 rpm, the cleaning efficiency appears to be decreased although the number of contacts between substrate 2 and cleaning body 32 is increased, because the rotating speed of cleaning body 32 is excessively high and contaminants attached to cleaning body 32 are re-attached to substrate 2 rather than comming off from cleaning body 32.

Referring to FIG. 6 where the rotating speed of substrate 2 is increased while the rotating speed of cleaning body 32 is fixed at 50 rpm, it has been found that the cleaning efficiency is gradually increased as the rotating speed of substrate 2 is increased, and reaches its peak when the rotating speed of substrate is 100 rpm. It has been also found that the cleaning efficiency is gradually decreased as the rotating speed of substrate 2 is further increased. It appears that the cleaning efficiency is decreased when the rotating speed of substrate 2 is lower than 100 rpm, because the number of contacts between substrate 2 and cleaning body 32 is small and contaminants that came off from substrate 2 by cleaning body 32 are re-attached to substrate 2. In the mean time, the cleaning efficiency appears to be decreased when the rotating speed of substrate 2 is higher than 100 rpm because cleaning body 32 is elevated and slipped aside by the impact of the cleaning solution interposed between substrate 2 and cleaning body 32, although the number of contacts between substrate 2 and cleaning body 32 is increased.

FIG. 7 shows a graph illustrating the cleaning efficiency where the rotational speed ratio of substrate 2 and cleaning body 32 (substrate:cleaning body) has been changed. For a substrate 2 where contaminants having relatively low adhesive power are attached (indicated as the plot with X mark), the cleaning efficiency reaches its peak at the ratio of about 2:1, shows 100% at the ratio range of about 1.5:1˜2.4:1, shows 90% at the ratio range of about 1:1˜3.5:1, and gradually decreases before and after the specified ranges. In contrast, for another substrate 2 where contaminants having relatively high adhesive power are attached (indicated as the plot with mark), the cleaning efficiency reaches its peak at the ratio of about 2:1, shows more than 90% at the ratio range of about 1.5:˜2.5:1, shows more than 80% at the ratio range of about 1.5:1˜3:1, and gradually decreases before and after the specified ranges.

The experimental results described above indicates that the cleaning efficiency is noticeably improved by setting the rotational speed ratio between substrate 2 and cleaning body 32 (substrate:cleaning body) as about 2:1. Specifically, the cleaning efficiency may be lower than 50% when the rotational speed ratio is set to be lower than 1:1 due to the re-attachment of the contaminants that came off from substrate 2. Moreover, when the rotational speed ratio is set to be higher than 4:1, the cleaning efficiency may be lower than 50% because cleaning body 32 is elevated and slipped aside by the impact of the cleaning solution interposed between substrate 2 and cleaning body 32. Accordingly, the rotational speed ratio may be set as 1:1˜3.5:1, 1.5:1˜3:1, or 1.5;1˜2.5:1 for a better cleaning efficiency

Moreover, since an appropriate rotational speed ratio may vary depending on an adhesive power of the detached materials such as an oxide layer or a resist layer, the relationship between the rotational speed ratio and cleaning efficiency may be investigated in advance, and a rotational speed ratio may then be set to give more than 90% of cleaning efficiency. In particular, the cleaning efficiency may be improved noticeably by setting the rotational speed ratio of substrate 2 and cleaning body 32 as near about 2:1.

Additionally, when the rotational speed ratio between substrate 2 rotated by rotating mechanism 19 and cleaning body 32 rotated by peripheral edge cleaning mechanism 21 is set to be about 2:1, the cleaning process is conducted by contacting substrate 2 with half of cleaning body 32 while substrate 2 is rotated by one rotation by rotating mechanism 19. As a result, substrate 2 may be cleaned by cleaning body 32 formed with different kinds of cleaning members 37, 38 such as a brush-shape cleaning member 37 made of PP (polypropylene) and a sponge-shape cleaning member 38 made of PVA (polyvynil alchol) each formed on one of divided areas where cleaning body 32 is divided by half along the circumferential direction. In this case, the brush-shape cleaning member 37 of cleaning body 32 may be used to clean one circumference of substrate 2, and, subsequently, the sponge-shape cleaning member 38 of cleaning body 32 may be used to clean another circumference of substrate 2. As a result, the cleaning efficiency may be further improved, because two cleaning processes take a turn. For example, the cleaning process by the brush-shape cleaning member 37 where relatively bigger contaminants can be detached, and another cleaning process by the sponge-shape cleaning member 38 where relatively small contaminants can be detached completely, can take a turn.

As described above, a cleaning process can be done by utilizing substrate liquid processing apparatus 1 having rotating mechanism 19 that rotates substrate 2, peripheral edge cleaning mechanism 21 that cleans the peripheral edge of substrate 2 with rotating cleaning body 32, and cleaning solution supply mechanism 22 that supplies the cleaning solution to substrate 2. When the cleaning process is performed by contacting cleaning body 32 to the peripheral edge of substrate 2, the cleaning efficiency of substrate 2 at the peripheral edge varies depending on the rotational direction and speed of substrate 2 and cleaning body 32. The cleaning efficiency of substrate 2 may be improved by setting the rotational direction of substrate 2 and cleaning body 32 to be an opposite direction so that the proceeding direction of substrate 2 and cleaning body 32 becomes the same at a contact portion where substrate 2 and cleaning body 32 are contacted. The cleaning efficiency may be further improved by setting the rotational speed ratio of substrate 2 and cleaning body 32 to be about 2:1, 1:1˜3.5:1, or 1.5:1˜3:1.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate liquid processing apparatus comprising:
a rotating mechanism that rotates a substrate;
a cleaning mechanism that cleans a peripheral edge of the substrate with a cleaning body configured to rotate; and
a supply mechanism that supplies a cleaning solution to the substrate,
wherein a rotational direction of the substrate by the rotating mechanism is configured to be opposite to a rotational direction of the cleaning body by the cleaning mechanism so that a proceeding direction of the substrate and the cleaning body is the same at a contact portion where the substrate and the cleaning body are contacted, and
wherein a ratio of a rotational velocity of the substrate rotated by the rotating mechanism to a rotational velocity of the cleaning body rotated by the cleaning mechanism ranges from about 1:1 to about 3.5:1.

2. The substrate liquid processing apparatus of claim 1, wherein the ratio of the rotational velocity of the substrate rotated by the rotating mechanism to the rotational velocity of the cleaning body rotated by the cleaning mechanism ranges from about 1.5:1 to about 3:1.

3. The substrate liquid processing apparatus of claim 1, wherein the ratio of the rotational velocity of the substrate rotated by the rotating mechanism to the rotational velocity of the cleaning body rotated by the cleaning mechanism is about 2:1.

4. The substrate liquid processing apparatus of claim 3, wherein the cleaning body is built with different kinds of cleaning members each formed on one of areas where the cleaning body is divided by half along a circumferential direction.

5. The substrate liquid processing apparatus of claim 4, wherein the cleaning body includes a brush-shape cleaning member and a sponge-shape cleaning member each formed on one of respective areas where the cleaning body is divided by half along the circumferential direction.

6. A substrate liquid processing method comprising:
rotating a substrate by a rotating mechanism;
cleaning a peripheral edge of the substrate by a cleaning body of a cleaning mechanism, where the cleaning body is configured to rotate by the cleaning mechanism;
supplying a cleaning solution to the substrate by a supply mechanism;
a first setting of setting a rotational direction of the substrate rotated by the rotating mechanism to be an opposite direction to a rotational direction of the cleaning body rotated by the cleaning mechanism so that a proceeding direction of the substrate and the cleaning body is the same at a contact portion where the substrate and the cleaning body are contacted; and
a second setting of setting a ratio of a rotational speed of the substrate rotated by the rotating mechanism to the rotational speed of the cleaning body rotated by the cleaning mechanism to range from about 1:1 to about 3.5:1.

7. The substrate liquid processing method of claim 6, wherein the ratio of the rotational speed of the substrate to the rotational velocity of the cleaning body at the second setting step is set to range from about 1.5:1 to about 3:1.

8. The substrate liquid processing method of claim 6, wherein the ratio of the rotational speed of the substrate to the rotational velocity of the cleaning body at the second setting step is set to be about 2:1.

9. A computer-readable medium storing a program that, when executed, causes a computer to perform a substrate liquid processing method comprising:
rotating a substrate by a rotating mechanism;
cleaning a peripheral edge of the substrate by a cleaning body of a cleaning mechanism, where the cleaning body is configured to rotate by the cleaning mechanism;
supplying a cleaning solution to the substrate by a supply mechanism;
a first setting of setting a rotational direction of the substrate rotated by the rotating mechanism to be an opposite direction to a rotational direction of the cleaning body rotated by the cleaning mechanism so that a proceeding direction of the substrate and the cleaning body is the same at a contact portion where the substrate and the cleaning body are contacted; and
a second setting of setting a ratio of a rotational speed of the substrate rotated by the rotating mechanism to the rotational speed of the cleaning body rotated by the cleaning mechanism to range from about 1:1 to about 3.5:1.

10. The computer-readable medium of claim 9, wherein the ratio of the rotational speed of the substrate to the rotational velocity of the cleaning body at the second setting step is set to range from about 1.5:1 to about 3:1.

11. The computer-readable medium of claim 9, wherein the ratio of the rotational velocity of the substrate to the rotational velocity of the cleaning body at the second setting step is set to be about 2:1.
